(19) United States
(12) Patent Application Publication
(10) Pub. No.: US 2014/0093165 A1
(43) Pub. Date: Apr. 3, 2014

(54) METHOD AND APPARATUS FOR RECOGNIZING COLOR

(71) Applicant: ASKEY COMPUTER CORP., New Taipei City (TW)

(72) Inventors: Chih-Sung Lai, New Taipei City (TW); Cheng-Hung Wu, New Taipei City (TW)

(73) Assignee: ASKEY COMPUTER CORP., NEW TAIPEI CITY (TW)

(21) Appl. No.: 13/737,960

(22) Filed: Jan. 10, 2013

(30) Foreign Application Priority Data
Sep. 28, 2012 (TW) 101136008

(51) Int. Cl. G06K 9/46

(52) U.S. Cl. CPC G06K 9/4652
USPC 382/165

(57) ABSTRACT

A method and an apparatus for recognizing color are provided. A color signal of a light source is obtained by a photo-sensing unit. After the color signal is received, a processing unit converts the color signal to a chromaticity coordinate, and compares the chromaticity coordinate with a gamut range to obtain a color corresponding to the light source.

### CROSS-REFERENCE TO RELATED APPLICATION

This application claims the priority benefit of Taiwan application serial no. 101136008, filed on Sep. 28, 2012. The entirety of the above-mentioned patent application is hereby incorporated by reference herein and made a part of this specification.

### TECHNICAL FIELD

The invention relates to a testing apparatus, and more particularly, to a method and an apparatus for recognizing color.

### BACKGROUND

As the electronic industry has been developed progressively, a wide variety of electronic products are manufactured in large quantities, such as computer equipments or network communication equipments etc. These electronic products are usually equipped with indication lights (such as light emitting diodes) configured to display the current product status. On the production lines, these indication lights may be configured to interpret whether the product functions normally or breakdowns etc. Therefore, the normal operation of indication lights influences on the quality of the products.

The majority of detection processes of production lines are generally detected in a manual manner. For instance, the products are determined whether they are defective units by recognizing the brightness, color, light-emitting and such of an indication light of a product. However, the concentration of human may always be harder to concentrate as the working hour gets longer, thereby the probability of the defective units without being detected may be increased or the brightness may not be determined directly by the human eyes. If there are multiple sets of indication lights on the apparatus under test needed to be detected, the measurement time may also be increased. The manual detection is not only time-wasting, it is more likely to generate errors due to human misjudgments, thereby lowering the quality of products.

Moreover, traditionally, the detection instruments (such as a camera, an oscilloscope, a multimeter or an illuminance meter etc.) may be utilized to detect, however, these detection instruments are slow and highly priced with few connection ports. If the number of detection points is increased, the detection time on the production lines may also be increased, which does not comply with the principle of efficiency. Additionally, if a camera is utilized to detect, it is easy to misjudge due to the testing environment.

### SUMMARY

Accordingly, the invention is directed to a method and an apparatus for recognizing color, which may provide accurate results for light-source detections, and may cut down on labor costs and ensure the quality of products.

The invention provides a method for recognizing color, adapted to utilize an electronic apparatus to recognize a color of a light source. The method includes: obtaining a first color signal of a first light source by a first photo-sensing unit, receiving the first color signal and executing a conversion procedure by a processing unit. The conversion procedure includes: converting the first color signal to a first chromaticity coordinate according to a gamut algorithm, thereafter, comparing the first chromaticity coordinate with a gamut range to obtain a first color corresponding to the first light source.

According to an embodiment of the invention, the step of obtaining the first color signal of the first light source by the first photo-sensing unit includes: detecting a plurality of color lights in the first light source respectively by the first photo-sensing unit, and accordingly generating frequency signals respectively corresponding to the color lights, wherein the first color signal includes the frequency signals, moreover, adjusting levels of control pins of the first photo-sensing unit according to a control signal, so that the first photo-sensing unit respectively detects at least one of a blue light, a red light and a green light in the first light source, or a combination thereof.

According to an embodiment of the invention, the electronic apparatus further includes a second photo-sensing unit, and the method for recognizing color further includes: obtaining a second color signal of a second light source by the second photo-sensing unit, receiving the second color signal and executing the conversion procedure by the processing unit. The conversion procedure includes: converting the second color signal to a second chromaticity coordinate according the gamut algorithm, and comparing the second chromaticity coordinate with the gamut range to obtain a second color corresponding to the second light source.

According to an embodiment of the invention, control pins of the first photo-sensing unit and the second photo-sensing unit are respectively coupled to a common pin that is one of a plurality of input/output pins of the processing unit. Accordingly, a control signal is respectively transmitted to the first photo-sensing unit and the second photo-sensing unit via the common pin, so as to control the first photo-sensing unit and the second photo-sensing.

According to an embodiment of the invention, after executing the conversion procedure by the processing unit, the first color may further be transmitted to a remote apparatus, alternatively, after determining whether the first color is complied with a predetermined color, the determined result is transmitted to the remote apparatus.

Moreover, the invention provides an apparatus for recognizing color including a plurality of photo-sensing units and a processing unit. The processing unit is coupled to the photo-sensing units. Each of the photo-sensing units is configured to detect a light source, and generate a corresponding color signal. The processing unit receives the color signals form the photo-sensing units, and a conversion procedure is executed by the processing unit. The conversion procedure includes: converting each of the color signals to a chromaticity coordinate according a gamut algorithm, and comparing the chromaticity coordinate with a gamut range to obtain a color corresponding to each of the light sources.

According to an embodiment of the invention, each of the photo-sensing units adjusts levels of control pins thereof according to a control signal, so that each of the photo-sensing units respectively detects a plurality of color lights in the corresponding light source, and accordingly, generates the color signal. For instance, the color lights include a blue light, a red light and a green light.

According to an embodiment of the invention, the photo-sensing units at least include a first photo-sensing unit and a second photo-sensing unit, and control pins of the first photo-sensing unit and the second photo-sensing unit are respectively coupled to a common pin of the processing unit (that is one of a plurality of input/output pins of the processing unit). The processing unit respectively transmits the control signal to the first photo-sensing unit and the second photo-sensing unit via the common pin, so as to control the first photo-sensing unit and the second photo-sensing unit.

According to the foregoing, in the invention, after the color signal is converted to the chromaticity coordinate, the chromaticity coordinate is then compared with the gamut range to obtain the color corresponding to the light source, thereby reducing the detection time on the production lines and decreasing the errors caused by human factors.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram illustrating an apparatus for recognizing color according to an embodiment of the invention.

FIG. 2 is a schematic block diagram illustrating a photo-sensing unit according to an embodiment of the invention.

FIG. 3 is a flowchart diagram illustrating a method for recognizing color according to an embodiment of the invention.

FIG. 4 is a schematic diagram illustrating a testing system according to an embodiment of the invention.

### DESCRIPTION OF THE EMBODIMENTS

Traditionally, the majority of detection processes utilized on production lines are recognized the defective units of products in a manual manner, however, besides the overly long detection time, the manual method is likely to generate errors based on human factors. To this end, the invention provides a method and an apparatus for recognizing color, which may automatically recognize the color of the light source, so that the detection time and the errors caused by the human factors may be reduced on the production lines, thereby completing the detections in a shortest time. In order to make the invention more comprehensible, embodiments listed below are described as examples to demonstrate that the invention is capable of being implemented.

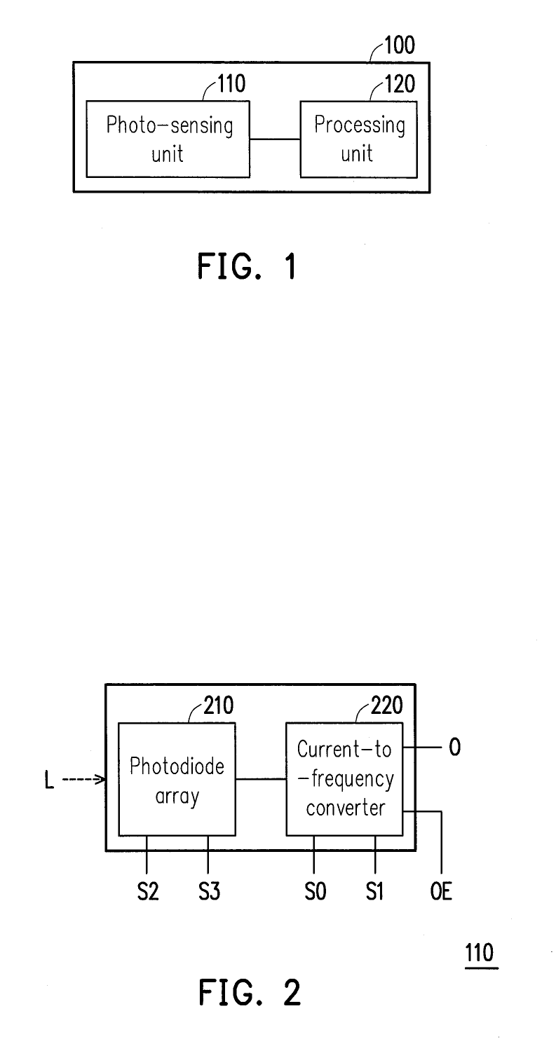

FIG. 1 is a schematic block diagram illustrating an apparatus for recognizing color according to an embodiment of the invention. Referring to FIG. 1, the apparatus for recognizing color 100 is an electronic apparatus at least including a photo-sensing unit 110 and a processing unit 120, wherein the processing unit 120 is coupled to the photo-sensing unit 110.

The photo-sensing unit 110 is configured to detect a light source, and accordingly generate a color signal corresponding to the light source. For example, FIG. 2 is a schematic block diagram illustrating a photo-sensing unit according to an embodiment of the invention. The embodiment is exemplified with the photo-sensing unit 110 in FIG. 1.

Referring to FIG. 2, the photo-sensing unit 110 includes a photodiode array 210 and a current-to-frequency converter 220. Wherein, a pin S2 and a pin S3 are configured to determine whether a light filter is enabled, that is to say selecting a type of the light filter. For instance, the photodiode array 210 includes three types of light filters, namely, a red light filter, a green light filter and a blue light filter. A pin S0 and a pin S1 are configured to determine the scaling of output frequencies. A pin OE is configured to control an output state of a pin O, and the pin O is an output pin for frequencies.

The photodiode array 210 may generate a current after sensing a light source L, thereafter, a corresponding frequency signal (that is, a color signal) is generated by the current-to-frequency converter 220 and outputted to the processing unit 120 via the pin O.

The processing unit 120 is, for instance, a micro control unit (MCU), a central processing unit (CPU), or a microprocessor etc. The processing unit 120 is configured to receive a plurality of color signals generated by the photo-sensing unit 110 and convert the received color signals to chromaticity coordinates according a gamut algorithm, and further compare each of the chromaticity coordinates with a gamut range to obtain a color corresponding to each of the light sources. Herein, the gamut algorithm is, for instance, the CIE (International Commission on Illumination) 1931 color space.

When the apparatus for recognizing color 100 detects a light source, the apparatus for recognizing color 100 may generate a color signal via the photo-sensing unit 110, and after the processing unit 120 receives the color signal, the color corresponding to the light source may be obtained through the program operation. The following description collocated with the apparatus for recognizing color 100 above further illustrates with another embodiment to describe every step of a method for recognizing color.

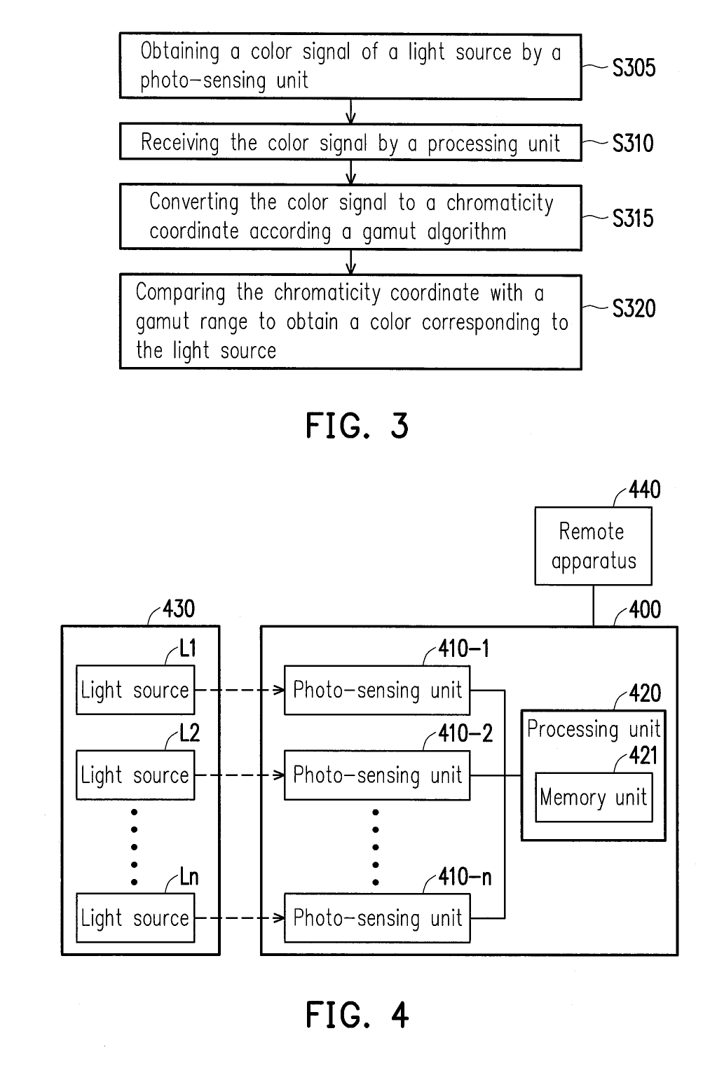

FIG. 3 is a flowchart diagram illustrating a method for recognizing color according to an embodiment of the invention. Referring to FIG. 1 and FIG. 3 simultaneously, in step S305, a color signal of a light source is obtained by the photo-sensing unit 110.

For instance, the levels of the control pins of the photo-sensing unit 110 are adjusted according to a control signal, so that the photo-sensing unit 110 respectively detects a plurality of color lights in the light source, and accordingly generates frequency signals respectively corresponding to the color lights. In other words, the aforementioned color signal includes the frequency signals of the color lights. The aforementioned color lights include a blue light, a red light and a green light.

In light of the trichromatic sensing theory, if the trichromatic values constituting of a color are known, the color of the light source under test may then be known. For the photo-sensing unit 110 is TCS3200, when a color filter is selected, it may only allow a particular primary color to pass through and prevent other primary colors to pass through. For instance, when the green filter is selected, only the green light in the light source may pass through, and the blue light and the red light may be prevented, such that the light intensity of the green light may be obtained. Similarly, the light intensity of the blue light may be obtained when the blue filter is selected, and the light intensity of the red light may be obtained when the red filter is selected. When the three values of red, blue and green are obtained, the color of the light projected on the TCS3200 may then be analysed.

For example, taking FIG. 2 as an example, the pin S2 and the pin S3 are configured to adjust the photodiode array 210 to be a particular type of color filter, thereby respectively receiving the blue light, the red light or the green light of the light source L. For instance, when both the pin S2 and the pin S3 are low levels, the red filter is selected. When both the pin S2 and the pin S3 are high levels, the green filter is selected. When the pin S2 is a low level and the pin S3 is a high level, the blue filter is selected. Accordingly, the red filter, the green filter and the blue filter are selected sequentially, and the three frequency signals for red, green and blue are detected (that is, the aforementioned color signal includes the three frequency signals of red, green and blue).

Subsequently, in step S310, the color signal is received by the processing unit 120. Thereafter, the processing unit 120 may execute the conversion procedure to the color signal, that is, step S315 and step S320.

In step S315, the processing unit 120 converts the color signal to the chromaticity coordinate according to the gamut algorithm. For the CIE 1931 color space, the red (R), the green (G) and the blue (B) may be converted to three tristimulus values according to the following equations, which respectively are X, Y and Z:

X=0.49×R+0.31×G+0.2×B;

Y=0.17697×R+0.8124×G+0.01063×B;

Z=0×R+0.01×G+0.99×B.

Thereafter, the three tristimulus values (X, Y, Z) are converted again to the chromaticity coordinates (x, y, z) according to the following equations, wherein x+y+z=1:

x=X/(X+Y+Z);

y=Y/(X+Y+Z);

z=Z/(X+Y+Z).

After converting to the chromaticity coordinates, in step S320, the processing unit 120 compares the chromaticity coordinate with a gamut range, so as to obtain a color corresponding to the light source. For instance, the gamut range of various colors may be obtained according to a chromaticity diagram of the CIE 1931 color space, and the gamut range is pre-recorded in a memory unit (not shown) of the processing unit 120. Accordingly, the processing unit 120 may query the gamut range stored in the memory unit to find out which color of the gamut range that the chromaticity coordinate is located within. Accordingly, the accuracy of color recognition may be enhanced by the operation of the processing unit 120.

Moreover, if the apparatus under test has a plurality of light sources, a common pin manner may further be utilized, so that the processing unit is coupled to a plurality of photo-sensing units. The following description illustrates another embodiment to describe further.

FIG. 4 is a schematic diagram illustrating a testing system according to an embodiment of the invention. Referring to FIG. 4, the testing system includes an apparatus for recognizing color 400, an apparatus under test 430 and a remote apparatus 440. Wherein, the apparatus for recognizing color 400 is, for instance, placed in front of the light sources L1˜Ln of the apparatus under test 430, and the apparatus for recognizing color 400 is coupled to the remote apparatus 440. Moreover, the apparatus for recognizing color 400 may also communicate with the remote apparatus 440 by an internet.

The apparatus for recognizing color 400 includes a processing unit 420 and photo-sensing units 410-1˜410-n. Herein, the function of the photo-sensing units 410-1˜410-n is similar to the photo-sensing unit 110 in FIG. 1, and the function of the processing unit 420 is similar to the processing unit 120 in FIG. 1, and thus are not to be reiterated herein. The related descriptions may be referred to FIG. 1.

In the embodiment, the photo-sensing units 410-1˜410-n are respectively coupled to the processing unit 420. Herein, the common pin manner may be utilized to perform coupling, so as to couple the plurality of photo-sensing units 410-1˜410-n simultaneously to detect a plurality of light sources L1˜Ln.

For example, it is assumed that the sharable amount of input/output pins provided by the processing unit 420 for the photo-sensing units 410-1˜410-n is four. This is taken as an example for illustrative purposes only, and the invention is not limited thereto.

Taking the photo-sensing units 410-1˜410-n are TCS3200 as an example, wherein the pins S0, S1, S2, S3 and OE are the control pins, the five control pins may be coupled in the common pin manner, meanwhile the pin O is an output pin, and thus it can not be coupled in the common pin manner.

According to the setup described above, the respective pins S0 of the four photo-sensing units (such as the photo-sensing units 410-1˜410-4) may be simultaneously coupled to an identical input/output pin of the processing unit 420, meanwhile, the respective pins S1 thereof may be simultaneously coupled to another input/output pin of the processing unit 420, and so forth for other control pins. Accordingly, the amount of the input/output pins utilized by the four photo-sensing units is nine, wherein the five input/output pins are coupled in the common pin manner, and the other four input/output pins are coupled to the output pins of the four photo-sensing units.

If the processing unit 420 has 36 input/output pins that may be utilized, the processing unit 420 may be coupled to 16 photo-sensing units (that is, the photo-sensing units 410-1˜410-16) by using the aforementioned method.

The processing unit 420 may respectively transmit the control signal to the four coupled photo-sensing units (such as the photo-sensing units 410-1˜410-4) by the common pin, so as to control the photo-sensing units. Moreover, the processing unit 420 includes the memory unit 421, and a gamut range is stored in the memory unit 421 so as to compare with the chromaticity coordinate.

Herein, after a color is obtained by the comparison of the processing unit 420, the obtained color may be further determined whether it is complied with the pre-determined color, so as to be informed whether the light source is abnormal. Thereafter, the determined result is then transmitted to the remote apparatus 440. Alternatively, after a color is obtained by the comparison of the processing unit 420, the color may be transmitted to the remote apparatus 440. Thereafter, the remote apparatus 440 determines whether the received color is complied with the pre-determined color.

To sum up, in the embodiments, after the color signal is converted to the chromaticity coordinate, the chromaticity coordinate is then compared with the gamut range, such that the accuracy of color recognition may be enhanced significantly. In addition, the common pin manner is utilized to couple the plurality of photo-sensing units to the processing unit, so that multiple sets may be detected at once, and thus the detection time will be much shorter than the traditional methods. Accordingly, other than saving the time for rechecking manually, the production capacity and the quality assurance on the production lines may be further verified, in order to guarantee the quality of products and increase the product competitiveness in the market.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for recognizing color, adapted to utilize an electronic apparatus to recognize a color of a light source, the method comprising:
obtaining a first color signal of a first light source by a first photo-sensing unit; and
receiving the first color signal and executing a conversion procedure by a processing unit, wherein the conversion procedure comprises:
converting the first color signal to a first chromaticity coordinate according to a gamut algorithm; and
comparing the first chromaticity coordinate with a gamut range to obtain a first color corresponding to the first light source.

2. The method for recognizing color as claimed in claim 1, wherein the step of obtaining the first color signal of the first light source by the first photo-sensing unit comprises:
detecting a plurality of color lights in the first light source respectively by the first photo-sensing unit, and accordingly generating frequency signals respectively corresponding to the color lights, wherein the first color signal includes the frequency signals.

3. The method for recognizing color as claimed in claim 2, wherein the step of detecting the color lights in the first light source respectively by the first photo-sensing unit comprises:
adjusting levels of control pins of the first photo-sensing unit according to a control signal, so that the first photo-sensing unit respectively detects one of a blue light, a red light and a green light in the first light source, or a combination thereof.

4. The method for recognizing color as claimed in claim 1, wherein the electronic apparatus further comprises a second photo-sensing unit, and the method for recognizing color further comprises:
obtaining a second color signal of a second light source by the second photo-sensing unit; and
receiving the second color signal and executing the conversion procedure by the processing unit, wherein the conversion procedure comprises:
converting the second color signal to a second chromaticity coordinate according to the gamut algorithm; and
comparing the second chromaticity coordinate with the gamut range to obtain a second color corresponding to the second light source.

5. The method for recognizing color as claimed in claim 4, wherein control pins of the first photo-sensing unit and the second photo-sensing unit are respectively coupled to a common pin that is one of a plurality of input/output pins of the processing unit, and the method for recognizing color further comprises:
transmitting a control signal respectively to the first photo-sensing unit and the second photo-sensing unit via the common pin, so as to control the first photo-sensing unit and the second photo-sensing.

6. The method for recognizing color as claimed in claim 1, wherein after the step of executing the conversion procedure by the processing unit, further comprising:
transmitting the first color to a remote apparatus.

7. The method for recognizing color as claimed in claim 1, wherein after the step of executing the conversion procedure by the processing unit, further comprising:
determining whether the first color is complied with a predetermined color; and
transmitting the determined result to a remote apparatus.

8. An apparatus for recognizing color, comprising:
a plurality of photo-sensing units, respectively detecting a plurality of light sources and generating a plurality of color signals; and
a processing unit, coupled to the photo-sensing units to receive the color signals from the photo-sensing units, wherein a conversion procedure is executed by the processing unit, and the conversion procedure comprises:
converting each of the color signals to a chromaticity coordinate according to a gamut algorithm; and
comparing the chromaticity coordinate with a gamut range to obtain a color corresponding to each of the light sources.

9. The apparatus for recognizing color as claimed in claim 8, wherein each of the photo-sensing units adjusts levels of control pins of each of the photo-sensing units according to a control signal, so that each of the photo-sensing units respectively detects one of a blue light, a red light and a green light in the corresponding light source or a combination thereof, and accordingly generates the color signal.

10. The apparatus for recognizing color as claimed in claim 8, wherein the photo-sensing units at least comprises a first photo-sensing unit and a second photo-sensing unit, wherein the control pins of the first photo-sensing unit and the second photo-sensing unit are respectively coupled to a common pin, and the common pin is one of a plurality of input/output pins of the processing unit.

11. The apparatus for recognizing color as claimed in claim 10, wherein the processing unit respectively transmits a control signal to the first photo-sensing unit and the second photo-sensing unit via the common pin, so as to control the first photo-sensing unit and the second photo-sensing unit.
